(19) United States
(12) Patent Application Publication
(10) Pub. No.: US 2017/0053608 A1
(43) Pub. Date: Feb. 23, 2017

(54) ARRAY SUBSTRATE, DISPLAY PANEL AND DISPLAY APPARATUS CONTAINING THE SAME, AND METHOD FOR DRIVING THE SAME

(71) Applicants: BOE TECHNOLOGY GROUP CO., LTD, Beijing (CN); Beijing BOE Optoelectronics Technology Co.,Ltd, Beijing (CN)

(72) Inventors: YUE LI, Beijing (CN); SHIJUN WANG, Beijing (CN); YANNA XUE, Beijing (CN); WENBO JIANG, Beijing (CN); WENJUN XIAO, Beijing (CN); LEI WANG, Beijing (CN)

(21) Appl. No.: 15/108,418

(22) PCT Filed: Dec. 28, 2015
(86) PCT No.: PCT/CN2015/099229

§ 371 Date: Jun. 27, 2016

(30) Foreign Application Priority Data
Apr. 21, 2015 (CN) 2015-10190830.X

(51) Int. Cl. G09G 3/36

(52) U.S. Cl. CPC G09G 3/3607; G09G 3/3674; G09G 2300/0452; G09G 2330/021; G09G 2310/08

(57) ABSTRACT

The present disclosure provides an array substrate. The array substrate includes a plurality of gate lines, a plurality of data lines, and a plurality of subpixels of at least three types. Each subpixel is connected to one data line and one gate line. Each data line is connected to at least two types but less than a total number of types of subpixels in the array substrate.

### CROSS-REFERENCES TO RELATED APPLICATIONS

This application claims the priority of Chinese patent application No. CN201510190830.X, filed on Mar. 26, 2015, the entire content of which is incorporated herein by reference.

### TECHNICAL FIELD

The present disclosure generally relates to the field of an array substrate, a display panel and a display apparatus containing the same, and a method for driving the same.

### BACKGROUND

Demands for higher visual resolution, i.e., the number of subpixels in a unit area in a display panel, continue to grow with technology development. However, sizes of subpixels cannot continue to decrease due to the limits in fabrication processes. Therefore, a “virtual display” technology has been used.

The virtual display technology improves display quality by changing the arrangement of the subpixels and the driving method of the subpixels. Users may experience improved display quality visually without increasing the number of the physical subpixels.

### BRIEF SUMMARY

One aspect of the present disclosure provides an array substrate. The array substrate includes a plurality of gate lines, a plurality of data lines, and a plurality of subpixels of at least three types. Each subpixel is connected to one data line and one gate line; and each data line is connected to at least two types but less than a total number of types of subpixels in the array substrate.

Optionally, each type of subpixels displays a different color.

Optionally, the plurality of data lines are along a column direction; and the plurality of gate lines are along a row direction.

Optionally, each data line connected to a subpixel is adjacent to the subpixel; each column of subpixels is between two data lines; and subpixels in each row are connected to a gate line adjacent to the row of subpixels.

Optionally, the types of subpixels include subpixels of a first color, subpixels of a second color, and subpixels of a third color; and subpixels connected to the each data line include two types of subpixels.

Optionally, the array substrate includes a plurality of repeating units, each repeating unit including twelve subpixels arranged in four rows and three columns. Each row of the subpixels includes a subpixel of the first color, subpixel of the second color, and a subpixel of the third color. An arrangement of subpixels in a second row is same as an arrangement of subpixels in a fourth row; in one column of subpixels, subpixels in a first row, the second row, and a third row each displays a different color from one another. In each column of subpixels, subpixels in the first row and in the second row are connected to a first data line on a first side of each subpixel, and subpixels in the third row and in the fourth row are each connected to a data line on a second side of each subpixel, the first side being opposite to the second side.

Optionally, in each repeating unit: the subpixels in the first row include a subpixel of the first color, a subpixel of the second color, and a subpixel of the third color; the subpixels in the second row and the fourth row include a subpixel of the third color, a subpixel of the first color, and a subpixel of the second color; and the subpixels in the third row include a subpixel of the second color, a subpixel of the third color, and a subpixel of the first color.

Optionally, subpixels of the first color, subpixels of the second color, and subpixels of the third color are red subpixels, green subpixels, and blue subpixels, respectively.

Another aspect of the present disclosure provides a display panel. The display panel includes one or more of the disclosed array substrates.

Another aspect of the present disclosure provides a display apparatus.

The display apparatus includes one or more of the disclosed display panels.

Another aspect of the present disclosure provides a method for driving an array substrate with a plurality of gate lines, a plurality of data lines, and a plurality of subpixels of at least three types. Each subpixel being connected to one data line and one gate line, and each data line being connected to at least two types but less than a total number of types of subpixels in the array substrate. The method includes inputting a gate signal into a gate line to select subpixels connected to the gate line; and inputting a display signal to data lines being connected to the at least two types of subpixels, and inputting a turn-off signal to rest of the data lines, wherein the turn-off signal turns off the subpixels and the display signal enables the subpixels to emit light.

Optionally, when displaying a pure color in a full frame, data lines disconnected to subpixels displaying the pure color output a turn-off signal to turn off the subpixels connected to the data lines.

Optionally, when displaying a pure color in a partial frame, data lines disconnected to subpixels displaying the pure color output a turn-off signal to turn off the subpixels connected to the data lines.

Optionally, in at least one frame: in a pixel unit with a plurality of subpixels, data lines connected to the subpixels in the pixel unit input a display signal to subpixels of one color, and input the turn-off signal to subpixels of other colors.

Optionally, in the at least one frame the pixel unit displays the one color in the one frame.

Optionally, the array substrate is a liquid crystal display array substrate;

and in one frame, display signals inputted into two adjacent data lines have opposite polarities.

Optionally, the types of subpixels include subpixels of a first color, subpixels of a second color, and subpixels of a third color; and subpixels connected to the each data line include two types of subpixels.

Optionally, the array substrate includes a plurality of repeating units, each repeating unit including twelve subpixels arranged in four rows and three columns. Each row of the subpixels includes a subpixel of the first color, a subpixel of the second color, and a subpixel of the third color. An arrangement of subpixels in a second row is same as an arrangement of subpixels in a fourth row. In one column of subpixels, subpixels in a first row, the second row, and a third row each displays a different color from one another. In each column of subpixels, subpixels in the first row and in the second row are connected to a first data line on a first side of each subpixel, and subpixels in the third row and in the fourth row are each connected to a data line on a second side of each subpixel, the first side being opposite to the second side.

Optionally, in each repeating unit: the subpixels in the first row include a subpixel of the first color, a subpixel of the second color, and a subpixel of the third color; the subpixels in the second row and the fourth row include a subpixel of the third color, a subpixel of the first color, and a subpixel of the second color; and the subpixels in the third row include a subpixel of the second color, a subpixel of the third color, and a subpixel of the first color.

Optionally, subpixels of the first color are red subpixels, subpixels of the second color are green subpixels, and subpixels of the third color are blue subpixels, respectively.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates the structure of a display panel;

FIG. 2 illustrates the sequence diagrams of a number of the data lines in the display panel illustrated in FIG. 1;

FIG. 3 illustrates an exemplary display panel structure in some embodiments;

FIG. 4 illustrates the sequence diagrams of a number of the data lines in the display panel illustrated in FIG. 3; and

FIG. 5 illustrates the polarity distribution of electrical field of an exemplary display panel in some embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It should be understood that the exemplary embodiments described herein are only intended to illustrate and explain the present disclosure and not to limit the disclosure. Wherever possible, the disclosed embodiments and the features disclosed in the exemplary embodiments may be re-arranged without departing from the scope of the present disclosure.

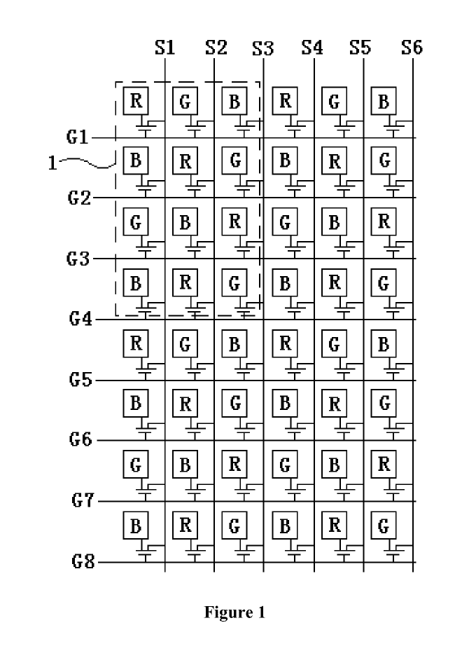

For example, FIG. 1 illustrates an arrangement of subpixels in a display panel using the virtual display technology. The subpixels are arranged as a plurality of repeating units 1 in the display panel. Each repeating unit 1 includes twelve subpixels, arranged in three columns and four rows. Each subpixel is connected to a data line on the right side and a gate line below the subpixel. For example, the subpixel can be connected to the data line and the gate line through a thin-film transistor (TFT). The subpixels display three colors. Defining by the color a subpixel displays, a subpixel can be a red subpixel R, a blue subpixel B, or a green subpixel G. In the disclosure, the expression that a subpixel of a certain color refers to a subpixel that displays a certain color.

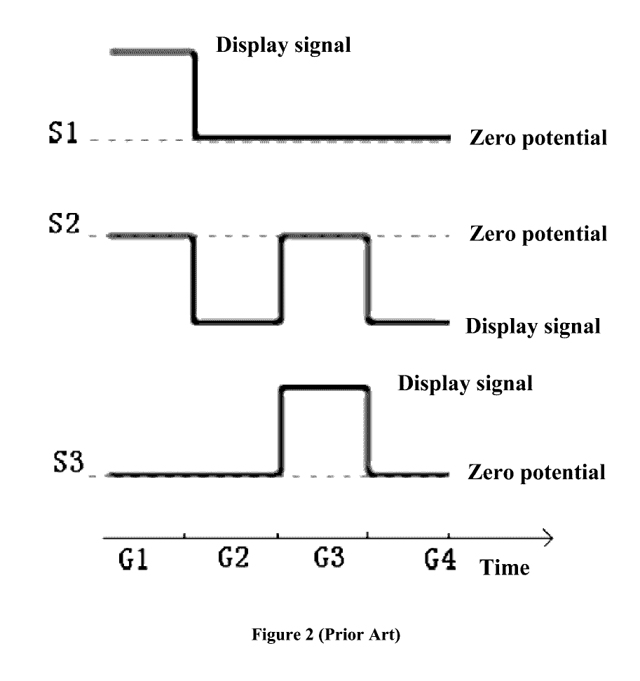

It has been noted that, the power consumption is relatively high when the display panel displays a pure color, in a full frame or a partial frame. For example, for a pure red full frame on a display panel, the time sequence signals of three data lines S1, S2, and S3 are illustrated in FIG. 2. G1, G2, G3, and G4 are “ON” times of corresponding gate lines on the time axis in FIG. 2. The subpixel is turned off to display black when the time sequence signal to the subpixel is a turn-off signal, such as a signal with zero potential. The subpixel is turned on to display light of a desired brightness level based on the time sequence signal when the time sequence signal to the subpixel is a display signal. In FIG. 2, the display signal of data line S2 is located below the turn-off signal because the display panel uses a column inversion method. That is, for any of two adjacent columns of subpixels, the electrical field applied on one column and the electrical field applied on the other column have opposite polarities. Thus, each data line, S1, S2, or S3 needs to input display signals to the subpixels. In addition, the turn-off signal and the display signal on or transmitted by the data line S2 may switch between each other with a high frequency, which increases the power consumption of the display panel. Embodiments of the present disclosure provide an array substrate. The array substrate may include a plurality of gate lines, a plurality of data lines, and subpixels of at least three colors. Each subpixel may be connected to one data line and one gate line. The subpixels connected to each data line may include at least two types, i.e., subpixels of two different colors. The types of subpixels connected to each data line may be less than the total number of different types of subpixels in the array substrate.

In other words, the disclosed array substrate may include subpixels of different colors. Each subpixel may be controlled by one gate line and one data line. Different from an existing array substrate, in the array substrate provided by the present disclosure, subpixels of at least two colors may be connected to each data line. The types of subpixels, i.e., the types of subpixels of different colors, connected to each data line, may be less than the total number of different types of subpixels in the array substrate. In other words, one data line may not be connected to the subpixels of at least one color.

In the disclosed array substrate, the types of subpixels of different colors connected to each data line may be less than the total number of different types of subpixels in the array substrate. Thus, when the array substrate is displaying a pure color in a full frame or in a partial frame, some data lines are not transmitting display signals to the subpixels. The switching frequency of signals in other data lines is also reduced. The power consumption of the array substrate can be reduced.

In some embodiments, the data lines may be arranged along a column direction, and the gate line may be arranged along a row direction. In certain embodiments, the data line connected to each subpixel may be adjacent to the subpixel. Each row of subpixels may be connected to a gate line adjacent to the row of subpixels.

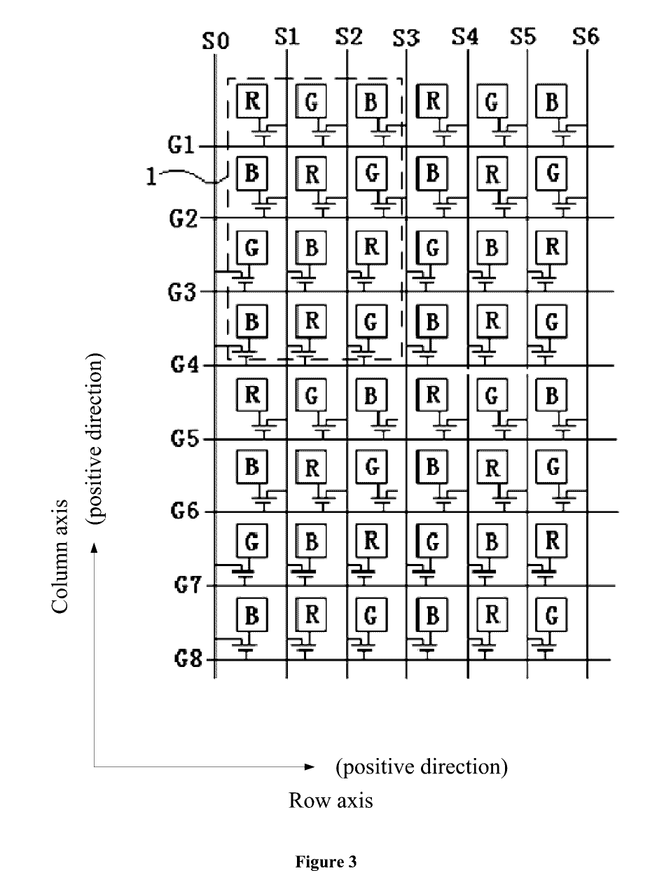

In other words, as shown in FIG. 3, in the disclosed array substrate, the gate lines may be arranged along the row direction and the data lines may be arranged along the column direction. Each data line may only be connected to the adjacent subpixels. The corresponding subpixels may only be connected to the adjacent data lines. Each gate line may be connected to one row of subpixels. This configuration may be used to reduce the length of a connection line between a data line and the corresponding subpixel.

In some embodiments, the subpixels in the disclosed array substrate include subpixels of three colors, i.e., subpixels of a first color, subpixels of a second color, and subpixels of a third color. In this case, each data line may be connected to subpixels of two colors.

In certain embodiments, subpixels of the first color, subpixels of the second color, and subpixels of the third color may be red subpixels R, green subpixels G, and blue subpixels B. The three colors, i.e., red, green, and blue, may be the most commonly used colors and be used for the most fundamental color mode (RGB mode) in an array substrate.

Specifically, in the description below, the embodiment is described using red subpixels R as the subpixels of the first color, green subpixels G as the subpixels of the second color, and blue subpixels B as the subpixels of the third subpixel. It should be noted that, subpixels and the corresponding colors may vary and should not be limited by the embodiments herein. The description is merely exemplary and should not limit the scope of the disclosure.

Specifically, an exemplary arrangement of subpixels in the array substrate is described below. As shown in FIG. 3, the subpixels in the array substrate include a plurality of repeating units 1. In other words, the subpixels in the array substrate may be divided into a plurality of repeating units 1 and the repeating units may have same arrangement/configuration. For illustrative purposes, FIG. 3 only shows data lines S0 to S6 and gate lines G1 to G6. In practice, data lines and gate lines may be arranged repeatedly in the array substrate.

Each repeating unit 1 may include 12 subpixels arranged in 4 rows and 3 columns. Subpixels in each row of subpixel may include a red subpixel R, a green subpixel G, and a blue subpixel B. The arrangement of subpixels in the second row may be the same as the arrangement of subpixels in the fourth row. Meanwhile, in one column, the subpixel in the first row, the subpixel in the second row, and the subpixel in the third row, may each have a different color than the other subpixels. In each column of a repeating unit 1 the subpixels in the first row and in the second row may be connected to a first data line on a first side of each subpixel; and the subpixels in the third row and the fourth row may be connected to a second data line on a second side of each subpixel. The second side is opposite to the first side. The first data line may be adjacent to the second data line.

In certain embodiments, as shown in FIG. 3, along the row direction indicated by the arrow, i.e., the positive direction of the row axis or from left to right in FIG. 3, the subpixels in the first row may include a red subpixel R, a green subpixel G, and a blue subpixel B. The subpixels in the second row and the fourth row may include a blue subpixel B, a red subpixel R, and a green subpixel G. The subpixels in the third row may include a green subpixel G, a blue subpixel B, and a red subpixel R.

Meanwhile, in each repeating unit 1, the subpixels in the first row and the second row may each be connected to the data line on the first side or a right side of each subpixel. The subpixels in the third row and the fourth row may each be connected to the data line on the second side or a left side of each subpixel. That is, except for the two data lines S0 and S6, each data line may be connected to two subpixels on the left side, and further connected to two subpixels on the right side. Repeatedly, the data line may be connected to two subpixels on the left side and further connected to two subpixels on the right side. The configuration or arrangement may repeat along the column direction. The repeating units 1 may be repeatedly arranged along the row direction and the column direction.

Thus, when the subpixels are arranged as described above and are connected to the data lines as described above, each data line may be connected to subpixels of two colors. When the array substrate is displaying a pure color, e.g., red, green, or blue, in a full frame or a partial frame, some data lines may transmit turn-off signals (e.g., with a zero potential) and may not transmit any display signals. The switching frequency between a display signal and a turn-off signal in other data lines may be desirably low. The power consumption of the array substrate may be reduced.

It should be noted that, because subpixels in the same column may be connected to data lines on both sides, data lines may be arranged between two adjacent columns of subpixels except for the columns of subpixels on the edges (i.e., the outermost columns) of the plurality of subpixels. As shown in FIG. 3, S0 and S6 may be arranged on the edges of the subpixels. S0 and S6 may each be connected to the column of subpixels on one side. That is, compared to an existing array substrate, only one data line S0 is added to the disclosed array substrate. Because the number of data lines used in an array substrate can be considerably large, e.g., hundreds or thousands of data lines, the effect of adding one data line S0 into the array substrate may be negligible.

Embodiments of the present disclosure may provide a method for driving the disclosed array substrate. In one disclosed method, a signal may be inputted into a gate line to select or enable the subpixel connected to the gate line. Further, turn-off signals for turning off the subpixels or display signals for turning on the subpixels may be inputted to the selected subpixels through the data lines.

That is, gate line signals may be inputted into each gate line sequentially so that the subpixels connected to the gate lines transmitting the gate lines signals are turned on for the data lines to transmit signals into the turned-on subpixels. After subpixels are turned on, data lines may transmit signals into the turned-on subpixels so that the turned-on subpixels may display pre-determined images. When one subpixel is designed to radiate light of a desired brightness level (the color of the light represents the color of the subpixel), a display signal corresponding to the desired brightness level may be inputted to the subpixel through the data line connected to the subpixel. When one subpixel is not designed to radiate light, a turned-off signal may be inputted into the subpixel through the data line connected to the subpixel. The turned-off signal may have zero potential.

In some embodiments, according to the array substrate with the repeating units 1 described above, for a pixel unit in at least one frame, the data lines may input a display signal to subpixels of one color and input turn-off signals (e.g., a zero potential) to subpixels of the other two colors. The pixel unit may include a plurality of subpixels. In the at least one frame, the pixel unit may display a pure color, corresponding to the subpixels inputted with the display signal.

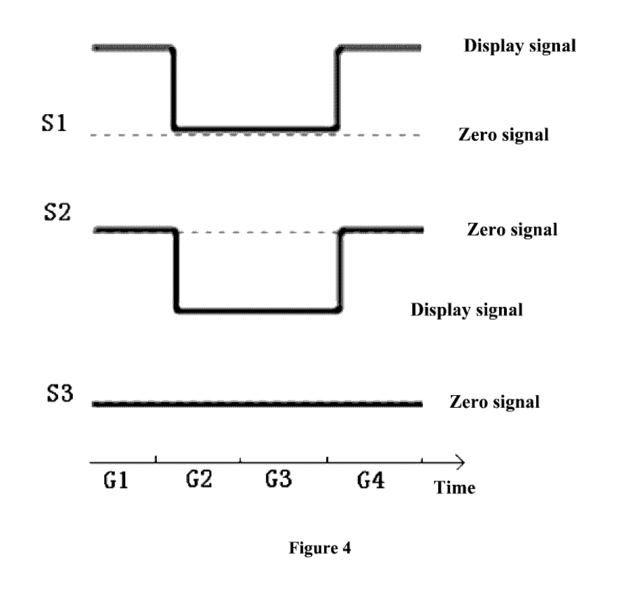

That is, for the array substrate described above, the color displayed can be a pure color in at least one frame. For example, when a repeating unit 1 is displaying an image of pure red, the signal lines, connected to the subpixels in the repeating unit 1, may only input display signals to the red subpixels R. The signal lines may input turn-off signals to the blue subpixels B and green subpixels G. Specifically, as shown in FIG. 4, because the data line S3 is not connected to the red subpixels R, the data line S3 may input a turn-off signal (e.g., a zero potential) when the repeating unit 1 is displaying an image of pure red. The other two data lines S1 and S2 may be connected to red subpixels and may each input a display signal into the corresponding red subpixel R when the red subpixels R are selected. The data lines S1 and S2 may input a turn-off signal into the corresponding red subpixel R in the repeating unit 1 when the repeating unit 1 is not displaying an image of pure red. Thus, the data line SO may keep inputting a low (e.g., zero) potential, and the switching frequency between a display signal and a turn-off signal transmitted by data lines S1 and S2 may be reduced. That is, when displaying a pure color, ⅓ of the data lines in the array substrate are turned off. The power consumption of the array substrate may thus be reduced.

In some embodiments, for a liquid crystal display array substrate or panel, in one frame, the polarities of display signals inputted into two adjacent data lines may be opposite. It should be noted that, in two adjacent frames, the polarities of display signals in one data line may be opposite.

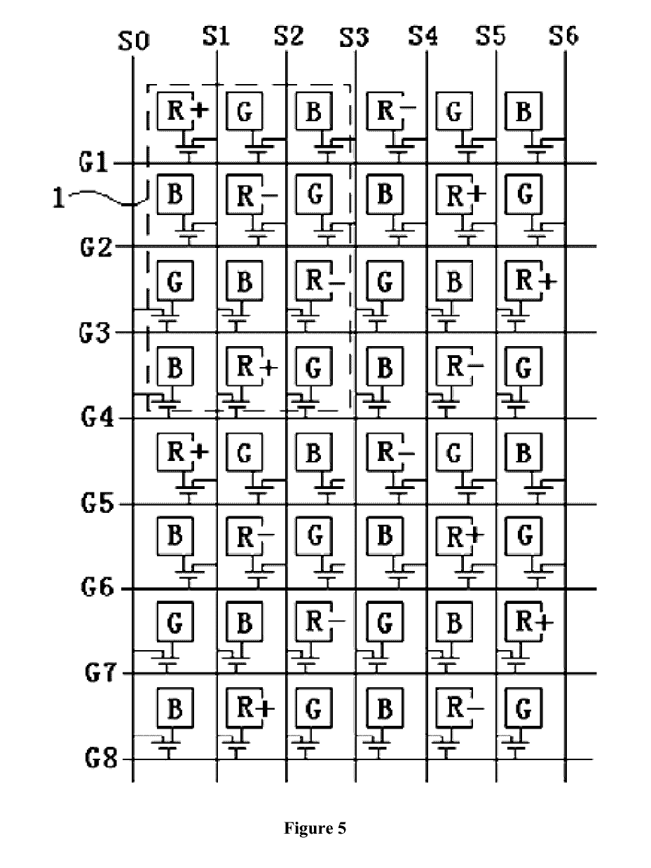

In other words, as shown in FIG. 4, the method to transmit signals to the subpixels in the disclosed array substrate may be similar to a column inversion method. Because of the arrangement of subpixels and the connection of data lines in the disclosed array substrate, the polarities of electrical fields in subpixels of the same color may be shown in FIG. 5. The red subpixels R are used as an example in FIG. 5. In FIG. 5, a positive electrical field is represented by a positive sign, “+”, and a negative electric field is represented by a negative sign, “−”.

Thus, in operation, the polarities of electrical fields in the subpixels may be distributed similar to a “Z” shape. That is, the distribution of electric fields in the subpixels may be similar to a “Z inversion” distribution. Under the effect of the “Z inversion,” the effect on the electrodes of adjacent subpixels, applied by the potentials of common electrodes, may be cancelled out. Thus, the potential of the common electrodes may be more stable. Flicker effect can be prevented or reduced, and display quality may be improved.

In other words, for the disclosed array substrate, when a simple column inversion method is used to input signals, a “Z inversion” effect may be realized. The display quality may be improved without increasing the complexity of the driving method.

The polarity of electric field may be relative to the potential of the common electrode. That is, the potential of the common electrode may be regarded as zero potential. If the potential of a display signal is higher than the potential of the common electrode, the display signal is a positive signal. If the potential of a display signal is lower than the potential of the common electrode, the display signal is a negative signal.

It should be noted that, the arrangement of subpixels in the repeating unit 1 in the disclosed embodiments is exemplary. Other arrangement of the subpixels may also be used. Further, the number of colors displayed by the subpixels, three colors in the disclosed embodiments, is only exemplary. More or fewer colors may also be displayed by the subpixels. For example, the subpixels may also include white (W) subpixels (RGBW mode) and/or yellow (Y) subpixels (RGBY mode). In addition, a data line may also be connected to subpixels in other columns instead of adjacent columns. Embodiments of the present disclosure requires that the number of different types of subpixels (i.e., the number of different colors display by the subpixels) connected to each data line may be at least two, and may be less than the total number of different types of subpixels. Embodiments of the present disclosure may implement other arrangements of subpixels meeting the aforementioned requirement in various display panels. The configurations of other arrangement are not repeated herein.

Embodiments of the present disclosure provide a display panel. The display panel may include one or more of the disclosed array substrates.

Embodiments of the present disclosure provide a display apparatus. The display apparatus may include one or more of the disclosed display panels. This display apparatus may be a liquid crystal display (LCD) panel, an electronic paper, an organic light-emitting diode (OLED) panel, a cell phone, a tablet, a television, a display, a laptop, a digital camera, a navigation, or any products or components with display functions.

The embodiments disclosed herein are exemplary only. Other applications, advantages, alternations, modifications, or equivalents to the disclosed embodiments are obvious to those skilled in the art and are intended to be encompassed within the scope of the present disclosure.

1-20. (canceled)

21. An array substrate, comprising a plurality of gate lines, a plurality of data lines, and a plurality of subpixels of at least three types, wherein:
each subpixel is connected to one data line and one gate line; and
each data line is connected to at least two types but less than a total number of types of subpixels in the array substrate.

22. The array substrate according to claim 21, wherein each type of subpixels displays a different color.

23. The array substrate according to claim 22, wherein:
the plurality of data lines are along a column direction; and
the plurality of gate lines are along a row direction.

24. The array substrate according to claim 21, wherein:
each data line connected to a subpixel is adjacent to the subpixel;
each column of subpixels is between two data lines; and
subpixels in each row are connected to a gate line adjacent to the row of subpixels.

25. The array substrate according to claim 21, wherein:
the types of subpixels include subpixels of a first color, subpixels of a second color, and subpixels of a third color; and
subpixels connected to the each data line include two types of subpixels.

26. The array substrate according to claim 25, including a plurality of repeating units, each repeating unit including twelve subpixels arranged in four rows and three columns, wherein:
each row of the subpixels includes a subpixel of the first color, a subpixel of the second color, and a subpixel of the third color;
an arrangement of subpixels in a second row is same as an arrangement of subpixels in a fourth row;
in one column of subpixels, subpixels in a first row, the second row, and a third row each displays a different color from one another; and
in each column of subpixels, subpixels in the first row and in the second row are connected to a first data line on a first side of each subpixel, and subpixels in the third row and in the fourth row are each connected to a data line on a second side of each subpixel, the first side being opposite to the second side.

27. The array substrate according to claim 26, wherein in each repeating unit:
the subpixels in the first row include a subpixel of the first color, a subpixel of the second color, and a subpixel of the third color;
the subpixels in the second row and the fourth row include a subpixel of the third color, a subpixel of the first color, and a subpixel of the second color; and
the subpixels in the third row include a subpixel of the second color, a subpixel of the third color, and a subpixel of the first color.

28. The array substrate according to claim 25, wherein:
subpixels of the first color, subpixels of the second color, and subpixels of the third color are red subpixels, green subpixels, and blue subpixels, respectively.

29. A display panel, comprising one or more of the array substrates according to claim 21.

30. A display apparatus, comprising one or more of the display panels according to claim 29.

31. A method for driving an array substrate with a plurality of gate lines, a plurality of data lines, and a plurality of subpixels of at least three types, each subpixel being connected to one data line and one gate line, and each data line being connected to at least two types but less than a total number of types of subpixels in the array substrate, comprising:
inputting a gate signal into a gate line to select subpixels connected to the gate line; and
inputting a display signal to data lines being connected to the at least two types of subpixels, and
inputting a turn-off signal to rest of the data lines, wherein the turn-off signal turns off the subpixels and the display signal enables the subpixels to emit light.

32. The method according to claim 31, wherein when displaying a pure color in a full frame, data lines disconnected to subpixels displaying the pure color output a turn-off signal to turn off the subpixels connected to the data lines.

33. The method according to claim 31, wherein when displaying a pure color in a partial frame, data lines disconnected to subpixels displaying the pure color output a turn-off signal to turn off the subpixels connected to the data lines.

34. The method according to claim 32, wherein in at least one frame:
in a pixel unit with a plurality of subpixels, data lines connected to the subpixels in the pixel unit input a display signal to subpixels of one color, and input the turn-off signal to subpixels of other colors.

35. The method according to claim 32, wherein in the at least one frame:
the pixel unit displays the one color in the one frame.

36. The method according to claim 31, wherein:
the array substrate is a liquid crystal display array substrate; and
in one frame, display signals inputted into two adjacent data lines have opposite polarities.

37. The method according to claim 31, wherein:
the types of subpixels include subpixels of a first color, subpixels of a second color, and subpixels of a third color; and
subpixels connected to the each data line include two types of subpixels.

38. The method according to claim 37, wherein:
the array substrate includes a plurality of repeating units, each repeating unit including twelve subpixels arranged in four rows and three columns, wherein:
each row of the subpixels includes a subpixel of the first color, a subpixel of the second color, and a subpixel of the third color;
an arrangement of subpixels in a second row is same as an arrangement of subpixels in a fourth row;
in one column of subpixels, subpixels in a first row, the second row, and a third row each displays a different color from one another; and
in each column of subpixels, subpixels in the first row and in the second row are connected to a first data line on a first side of each subpixel, and subpixels in the third row and in the fourth row are each connected to a data line on a second side of each subpixel, the first side being opposite to the second side.

39. The method according to claim 38, wherein in each repeating unit:
the subpixels in the first row include a subpixel of the first color, a subpixel of the second color, and a subpixel of the third color;
the subpixels in the second row and the fourth row include a subpixel of the third color, a subpixel of the first color, and a subpixel of the second color; and
the subpixels in the third row include a subpixel of the second color, a subpixel of the third color, and a subpixel of the first color.

40. The method according to claim 37, wherein:
subpixels of the first color are red subpixels, subpixels of the second color are green subpixels, and subpixels of the third color are blue subpixels, respectively.
